(19) United States
(12) Patent Application Publication
(10) Pub. No.: US 2025/0060246 A1
(43) Pub. Date: Feb. 20, 2025

(54) DISTRIBUTED ACOUSTIC DEFECT DETECTION SYSTEM UTILIZING OPTICAL INTERFEROMETERS

(71) Applicant: Pure Technologies U.S. Inc., Columbia, MD (US)

(72) Inventors: John Allison McIntyre, Calgary (CA); Marshall Glen Kennedy, Calgary (CA)

(21) Appl. No.: 18/806,958

(22) Filed: Aug. 16, 2024

Related U.S. Application Data
(60) Provisional application No. 63/520,191, filed on Aug. 17, 2023.

(51) Int. Cl. G01H 9/00; G01D 5/353

(52) U.S. Cl. CPC G01H 9/004; G01D 5/35306

(57) ABSTRACT

A distributed acoustic sensing system can include an optical interferometer. The optical interferometer can include an optical fiber coupler to split optical light signals, and an optical fiber delay coil to introduce a controlled time delay in one of the paths. At least one path can form a loop, enabling controlled delay and temporary storage of light, resulting in interference patterns. The system can progressively mitigate noise or distortion, improving sensitivity and/or signal reception quality for defect detection.

### CROSS-REFERENCE TO RELATED APPLICATION

This application claims the benefit of and claims priority to U.S. Provisional Application No. 63/520,191, filed Aug. 17, 2023, entitled “Distributed Acoustic Defect Detection System Utilizing Fiber Ring Resonator Interferometers,” the content of which is hereby incorporated herein by reference in its entirety.

### FIELD

The present inventive concepts relate generally to optical signal processing and, more specifically, to systems and methods for distributed acoustic defect detection utilizing optical interferometers.

### BACKGROUND

Distributed fiber-optic acoustic sensors often employ optical fibers to detect sound, vibration, or various acoustic signals across vast distances. These sensors can be particularly valuable in monitoring civil structures, such as bridges, pipelines, or other infrastructure components. By transmitting light through an optical fiber, the sensors are capable of detecting events of interest such as tension failures, leaks, or strikes during construction. For example, these events of interest can cause changes in the light's properties, which the sensors can interpret. By analyzing these changes, the system can detect and locate the source of the acoustic or vibrational events. However, challenges can arise when the optical fiber cable is placed within or proximate active pipelines or other structures subject to movement. In these situations, the cable may be in variable motion, leading to the generation of phase noise. This noise can often overwhelm or mask the actual signal of interest, making it challenging to accurately detect and interpret the events of interest.

### SUMMARY

A distributed acoustic sensing system can include an optical interferometer. The optical interferometer can include an optical fiber coupler to split optical light signals, and an optical fiber delay coil to introduce a controlled time delay in one of the paths. At least one path can form a loop, enabling controlled delay and temporary storage of light, resulting in interference patterns. The system can progressively mitigate noise or distortion, improving sensitivity and/or signal reception quality for defect detection.

Certain illustrative examples are described in the following numbered clauses:

Clause 1. An optical fiber interferometer, comprising
a first optical coupler configured for splitting power of input light signals into a plurality paths of light signals; and
a first optical fiber coil configured for: receiving a path of the plurality paths of light signals output from the first optical coupler;
generating a delay in time of the path of the plurality paths of light signals; and
inputting to the first optical coupler delayed light signals for the first optical coupler to combine the delayed light signals with subsequent signals input to the first optical coupler.

Clause 2. The optical fiber interferometer of clause 1, wherein the first optical coupler is a 1×2, 2×2 or 3×3 coupler.

Clause 3. The optical fiber interferometer of clause 1, wherein the first optical coupler is a 3×3 coupler.

Clause 4. The optical fiber interferometer of clause 1, wherein the first optical fiber coil has a length of 1 m-50 m or longer.

Clause 5. The optical fiber interferometer of clause 1, wherein the delay is 2 μs.

Clause 6. An optical fiber interferometer, comprising:
a first optical coupler configured for splitting power of input light signals into a plurality paths of light signals; and
a second coupler for splitting a path of the plurality paths of light signals to second plurality of paths of light signals;
a first optical fiber coil configured for:
receiving a path of the second plurality of paths of light signals output from the second optical coupler;
generating a delay in time of the path of the second plurality of paths of light signals; and
inputting to the first optical coupler delayed light signals for the first optical coupler to combine the delayed light signals with subsequent signals input to the optical coupler.

Clause 7. The optical fiber interferometer of clause 1, further comprising a second coupler for generating the input light signals, and a third coupler for combining a path of light signals output from the first coupler with a path of light signals generated from the second coupler.

Clause 8. The optical fiber interferometer of clause 1, further comprising a second optical fiber coil for receiving a first path of output light signals from the first coupler, and a second coupler for combining a second path of light signals output from the first coupler and second delay light signals from the second optical fiber.

Clause 9. The optical fiber interferometer of clause 6, further comprising a second optical fiber coil for receiving second light signals from the second coupler, and a third coupler for combining second light signal output from the first coupler and second delay signals from the second optical fiber coil.

Clause 10. The optical fiber interferometer of clause 7, further comprising a second optical fiber coil for receiving second output signals from the first coupler and generating second delay signals, and inputting the second delay signals to the first coupler.

Clause 11. The optical fiber interferometer of clause 10, wherein the second coupler is a 3×3 coupler.

Clause 12. The optical fiber interferometer of clause 7, further comprising a second optical fiber coil configured to receive a first path of light signals from the third coupler, generate a second delay in time, and input second delayed light signals to the third coupler.

Clause 13. The optical fiber interferometer of clause 1, further comprising an amplifier for amplifying the path of the plurality paths of light signals, and for inputting amplified light signals to the first optical fiber coil.

Clause 14. An optical fiber interferometer, comprising:
a first optical coupler configured for splitting power of input light signals into a plurality paths of light signals;
an amplifier for amplifying the a path of the plurality paths of light signals;
a second optical coupler;
a first optical fiber coil configured for:
receiving amplified light signals output from the amplifier;
generating a delay in time of the amplified light signals; and
inputting to the second optical coupler delayed light signals for the second optical coupler to combine the delayed light signals with subsequent signals output from the first optical coupler.

Clause 15. An optical fiber interferometer, comprising:
a optical coupler for outputting a plurality paths of light signals;
a first optical fiber interferometer of clause 1 for receiving a first path of the plurality paths of light signals; and
a second optical fiber interferometer of clause 1 for receiving a second path of the plurality paths of light signals.

Clause 16. The optical fiber interferometer of clause 15, wherein the optical coupler is a demux.

Clause 17. An optical fiber interferometer, comprising
a optical coupler for outputting a plurality paths of light signals;
a first optical fiber interferometer of clause 1 for receiving a first path and a second path of the plurality paths of light signals.

Clause 18. The optical fiber interferometer of clause 17, where the optical coupler is a demux.

Clause 19. The optical fiber interferometer of clause 1, further comprising a depolarizer for depolarizing the path of the plurality paths of light signals output from the first optical coupler and input the depolarized signals to the first optical fiber coil.

Clause 20. The optical fiber interferometer of clause 19, further comprising a second depolarizer for depolarizing the input light signals.

Clause 21. The optical fiber interferometer of clause 15, wherein the optical coupler is a polarization state splitter and outputs a first path of vertical light signals and a second path horizontal light signals.

Clause 22. The optical fiber interferometer of clause 15, wherein the optical coupler is a demux for separating the input light signals to ITU 35 light signals and ITU 35 light signals.

Clause 23. The optical fiber interferometer of clause 15, further comprising a third optical fiber coil for generating a third delay in time to the second path of the plurality paths of light signals.

Clause 24. A sensing system comprising:
a sensing optical fiber for sensing a defect of a structure;
an optical fiber interferometer; and
an optical circulator for transmitting light signals from the sensing optical fiber to the optical fiber interferometer;
the optical fiber interferometer comprising
a first optical coupler configured for splitting power of the light signals received from the optical to a plurality of light signals; and
a first optical fiber coil configured for: receiving a path of the plurality of light signals output from the first optical coupler;
generating a delay in time of the path of the plurality paths of light signals; and
inputting into the first optical coupler delayed light signals for the optical coupler to combine the delayed light signals with subsequent signals input to the first optical coupler from the optical circulator.

Clause 25. A method for temporal diversity processing of optical signals, the method comprising:
splitting an incoming light signal into multiple paths;
implementing a controlled delay in one of the paths, creating a delayed signal that is temporarily stored within a circulatory system;
allowing the delayed signal to interact with subsequent incoming light signals, thereby forming a new delayed signal and corresponding interference patterns for each interaction; and
combining the newly formed signals into a single output signal.

Clause 26. A distributed acoustic sensing system, comprising:
a optical interferometer operatively coupled to a sensing fiber, the optical interferometer being configured to receive optical light signals from the sensing fiber, the optical interferometer further comprising:
an optical fiber coupler configured to split and combine the optical light signals;
an optical fiber delay coil configured to introduce a controlled time delay in the transmitted signals, thereby enabling temporary storage for subsequent interference with incoming light signals;
wherein the optical interferometer forms dynamic interference patterns characterized by alternating bright and dark fringes, the interference patterns encoding information therein.

Clause 27. The distributed acoustic sensing system of clause 26, further comprising a hybrid phase detection device configured to estimate the phase and/or amplitude of the incoming signals.

Clause 28. The distributed acoustic sensing system of clauses 26 or 27, further comprising:
a light source configured to generate light signals for sensing operation;
a light receiver configured to capture the light signals after interaction with a monitored environment;
a variable optical attenuator configured to regulate the power levels of the transmitted light signals;
a pulse modulator configured to manipulate the light signals to form specific pulse shapes;
an optical amplifier configured to boost the power of the light signals;
a filter configured to transmit light signals within a certain range of wavelengths;
an optical circulator configured to guide light signals in a unidirectional manner;
a sensing fiber configured to provide a channel for light signals to interact with the environment under investigation;
receivers configured to convert the optical signals into electrical signals; and
a signal acquisition and processing system configured to receive and process the output signals from the hybrid phase detection device and/or the signals from the optical receivers, and perform signal analysis to enable precise detection, localization, or characterization of acoustic disturbances or structural anomalies.

Clause 29. An optical interferometer comprising:
an optical coupler configured to combine first light signals traversing a first path and second light signals traversing a second path to form combined light signals, the optical coupler further configured to separate the combined light signals into at least the second path and a third path,
wherein the first light signals correspond to optical light signals that are indicative of acoustic disturbances across a distributed acoustic sensing system, and wherein the second path is a feedback loop; and
an optical fiber delay coil arranged along the second path and configured to introduce a controlled time delay in the second light signals traversing the second path,
wherein a signal acquisition and processing system determines characteristics of the acoustic disturbances based at least in part on third light signals traversing the third path.

Clause 30. The optical interferometer of clause 29, wherein the optical coupler receives the first light signals from a sensing optical fiber positioned proximate to a structure such that the first light signals are modulated by acoustic disturbances corresponding to at least one of structural defects or environmental changes in the structure.

Clause 31. The optical interferometer of clause 29, wherein the optical coupler is a first optical coupler, the optical interferometer further comprising a second optical coupler arranged along the second path, wherein the second optical coupler is configured to receive a second path signal from the first optical coupler, and separate the second path signal into a path to the signal acquisition and processing system and a path to the optical fiber delay coil.

Clause 32. The optical interferometer of clause 29, wherein the optical coupler is a first optical coupler, wherein the combined light signals are first combined light signals, and wherein the optical interferometer further comprises:
a second optical coupler arranged along the first path, wherein the second optical coupler is configured to receive the optical light signals that are indicative of acoustic disturbances and separate the optical light signals into the first light signals and a fourth path; and
a third optical coupler configured to combine light signals traversing the third path and light signals traversing the fourth path to form second combined light signals, the optical coupler further configured to separate the combined light signals into at least a fifth path and a sixth path.

Clause 33. The optical interferometer of clause 29, wherein the optical fiber delay coil is a first optical fiber delay coil, and wherein the optical interferometer further comprises a second optical fiber delay coil arranged along the third path.

Clause 34. The optical interferometer of clause 33, wherein the optical coupler is a first optical coupler, wherein the combined light signals are first combined light signals, and wherein the optical interferometer further comprises a second optical coupler arranged along the third path, wherein the second optical coupler is configured to combine an output of the second optical fiber delay coil and light signal from the first optical coupler to second combined light signals, the second optical coupler further configured to separate the second combined light signals into at least two paths.

Clause 35. The optical interferometer of clause 29, wherein the optical coupler is a 1×2, 2×2, or 3×3 coupler.

Clause 36. The optical interferometer of clause 29, wherein the optical fiber delay coil has a length less than 50 meters.

Clause 37. The optical interferometer of clause 29, wherein the distributed acoustic sensing system includes a plurality of optical interferometers arranged in parallel.

Clause 38. The optical interferometer of clause 29, wherein the controlled time delay is about 2 μs.

Clause 39. A distributed acoustic sensing system, comprising:
a sensing optical fiber configured to transmit first light signals along a first path, the sensing optical fiber positioned proximate to a structure such that the first light signals are modulated by acoustic disturbances corresponding to at least one of structural defects or environmental changes in the structure; and
an optical interferometer, comprising:
an optical coupler configured to receive the first light signals and combine first light signals traversing the first path and second light signals traversing a second path to form combined light signals, the optical coupler further configured to separate the combined light signals into at least the second path and a third path, wherein the second path is a feedback loop; and
an optical fiber delay coil arranged along the second path and configured to introduce a controlled time delay in the second light signals traversing the second path.
wherein a signal acquisition and processing system determines characteristics of the acoustic disturbances based at least in part on third light signals traversing the third path.

Clause 40. The distributed acoustic sensing system of clause 39, further comprising the signal acquisition and processing system.

Clause 41. The distributed acoustic sensing system of clause 39, wherein the optical coupler is a 1×2, 2×2, or 3×3 coupler.

Clause 42. The distributed acoustic sensing system of clause 39, further comprising a second optical fiber delay coil arranged along the second path and configured to introduce an additional controlled time delay in the second light signals traversing the second path.

Clause 43. The distributed acoustic sensing system of clause 39, wherein the controlled time delay introduced by the optical fiber delay coil creates interference patterns characterized by alternating light and dark bands, wherein the system further comprises a signal acquisition and processing system configured to:
receive and digitize the interference patterns;
analyze phase shifts in the interference patterns to detect acoustic disturbances; and
determine characteristics of the acoustic disturbances based on the interference patterns.

Clause 44. The distributed acoustic sensing system of clause 43, wherein the characteristics of the acoustic disturbances comprise at least a location of the acoustic disturbances, wherein the location comprises an indication of an approximate position along a length of the sensing optical fiber where the acoustic disturbances are detected.

Clause 45. The distributed acoustic sensing system of clause 43, further comprising a hybrid phase detection device, wherein the hybrid phase detection device is configured to:
split the third light signals into two or more paths;
mix the split light signals with a reference signal to produce in-phase (I) and quadrature (Q) components;
generate phase-shifted output signals based on the I and Q components;
compare the phase-shifted output signals to determine phase differences; and
provide phase difference data to the signal acquisition and processing system for further analysis of the acoustic disturbances.

Clause 46. A method for detecting acoustic disturbances using an optical interferometer, comprising:
splitting first light signals indicative of acoustic disturbances into a first path and a second path using an optical coupler, wherein the first light signals traverse the first path and the second path;
introducing a controlled time delay in second light signals traversing the second path using an optical fiber delay coil arranged along the second path;
combining the first light signals and the time-delayed second light signals to form combined light signals using the optical coupler; and
separating the combined light signals into at least the second path and a third path using the optical coupler, wherein the second path forms a feedback loop for subsequent signals and the third path provides output signals;
wherein a signal acquisition and processing system determines characteristics of the acoustic disturbances based at least in part on the light signals traversing the third path.

Clause 47. The method of clause 46, wherein the controlled time delay introduced by the optical fiber delay coil creates interference patterns characterized by alternating light and dark bands further comprising:
analyzing phase shifts in the interference patterns to detect acoustic disturbances; and
determining characteristics of the acoustic disturbances based on the interference patterns.

Clause 48. The method of clause 46, wherein the characteristics of the acoustic disturbances comprise at least a location of the acoustic disturbances, wherein the location comprises an indication of an approximate position along a length of a sensing optical fiber where the acoustic disturbances are detected.

### BRIEF DESCRIPTION OF THE DRAWINGS

Throughout the drawings, reference numbers can be re-used to indicate correspondence between referenced elements. The drawings are provided to illustrate embodiments of the present disclosure and do not to limit the scope thereof.

FIG. 1 is a schematic diagram illustrating an embodiment of a distributed acoustic sensing system, incorporating an optical interferometer.

FIG. 2 is a schematic diagram illustrating an example distributed acoustic sensing system.

FIGS. 3-10, 11A, and 11B are schematic diagrams that illustrates implementations of example optical interferometers.

FIG. 12A is a schematic diagram illustrating an example distributed acoustic sensing system that includes an example optical interferometer.

FIGS. 12B, 12C, 13, 14A, 14B, and 15 are schematic diagrams that illustrates implementations of example optical interferometers.

FIG. 16 is a schematic diagram illustrating an example distributed acoustic sensing system that includes an example optical interferometer.

FIG. 17 is a schematic diagram that illustrates an implementation of an example optical interferometer.

FIG. 18 is a schematic diagram illustrating an embodiment of a distributed acoustic sensing system, incorporating an optical interferometer.

FIG. 19 is a schematic diagram illustrating an embodiment of a distributed acoustic anomaly locator system that includes an optical frequency comb generator.

Similar reference numerals may have been used in different figures to denote similar components.

### DETAILED DESCRIPTION

### Introduction

Maintaining the integrity and health of civil infrastructure such as bridges, pipelines, dams, and other constructed structures can be critical in ensuring public safety and maintaining the effective operation of essential services. To that end, it can be important to monitor these structures for issues that might arise during their construction, or over their operational lifespan due to factors such as aging, usage, natural disasters, or other events. This monitoring can facilitate the detection of issues, such as, but not limited to, tensioned reinforcing failures, leaks, structural instabilities, corrosion, material degradation, foundation problems, etc.

Some techniques for monitoring the infrastructure utilize optical fiber-based sensing. Optical fibers can detect minute changes in their surroundings, transforming them into readable signals that can be analyzed to identify potential problems. These systems offer distributed sensing capabilities and high sensitivity, making them well-suited for monitoring large-scale civil structures.

However, employing optical fiber sensors can introduce various challenges, such as those related to signal fading, sensitivity, detection accuracy, or noise. For example, in environments with dynamic factors such as flowing pipelines, movement or vibrations can introduce noise to the optical fiber sensors, potentially compromising the reliability or accuracy of the sensor readings. At times, this noise can be greater than the actual signal of interest, complicating the accurate detection of potential infrastructural issues. In addition, signal fading can occur (e.g., due to loss of light power), which could affect the performance of the sensor. The sensitivity of the sensor can also pose challenges, as lower sensitivity might cause smaller, but potentially significant, defects to go unnoticed. These disturbances can manifest as phase noise, which influences the overall performance of the sensing system. Thus, managing and mitigating noise, enhancing sensitivity, minimizing signal fading, and improving detection accuracy can be important aspects to consider when utilizing optical fiber sensors.

To address these and other challenges, the present disclosure introduces a distributed acoustic sensing system that implements temporal diversity in processing light signals. The distributed acoustic sensing system receives incoming light signals, which can be modulated and directed along specific paths. Part of these light signals are then delayed and stored for future mixing with new incoming signals. By delaying and storing part of the light signals for future mixing with new incoming signals, the distributed acoustic sensing system advantageously allows for multiple data sampling points over a time period, thereby enhancing the resolution and accuracy of defect detection and localization. In some cases, the non-delayed intensity output specifically contributes to improved location accuracy. Additionally, the delay signals can advantageously counteract instances of signal fading, thus preserving the integrity of the signal. Furthermore, the distributed acoustic sensing system advantageously provides an effective way to increase the overall detection accuracy, while also reducing the likelihood of missing any transient or small-scale anomalies that might otherwise go unnoticed in a traditional single-pass monitoring scenario.

In some cases, a distributed acoustic sensing system incorporates a ring interferometer, an optical device that leverages the wave properties of light and the principle of interference. When multiple light waves converge within the ring interferometer, they can interact constructively or destructively, forming an interference pattern characterized by alternating bright and dark fringes. This pattern can encode information about the light's path, such as length, phase, or encountered anomalies. The ring interferometer can operate by splitting incoming light signals into multiple paths, with at least one path forming a loop (sometimes referred to as a “ring”). As the light circulates within the ring, it experiences a controlled delay and temporary storage. This delay can enable the stored light to interfere with subsequent incoming light signals, resulting in new interference patterns. By analyzing these interference patterns, the distributed acoustic sensing system can identify potential structural defects and gain insights into the monitored environment.

The integration of storage and delay via the ring interferometer can provide the distributed acoustic sensing system with time diversity, thereby offering a second opportunity or multiple opportunities to identify defects (e.g., if they were missed in the initial light signal). This recirculation of light advantageously enhances the distributed acoustic sensing system's reliability and precision in defect detection. Moreover, the ring interferometer advantageously contributes to improving signal quality by progressively mitigating or nullifying noise and distortions as the light signal circulates within the ring.

The disclosed distributed acoustic sensing systems offer advancements in sensitivity and signal reception quality compared to traditional monitoring systems, such as single-pass monitoring systems. The inventive concepts herein address the challenge of signal fading by effectively preserving signal information, resulting in improved defect identification capabilities. With enhanced sensitivity and improved signal preservation, the disclosed distributed acoustic sensing systems provide robust and reliable solutions for distributed acoustic defect detection. These advancements elevate the capabilities of structural monitoring technology, enabling precise and effective detection of defects in various applications.

### Example Embodiments

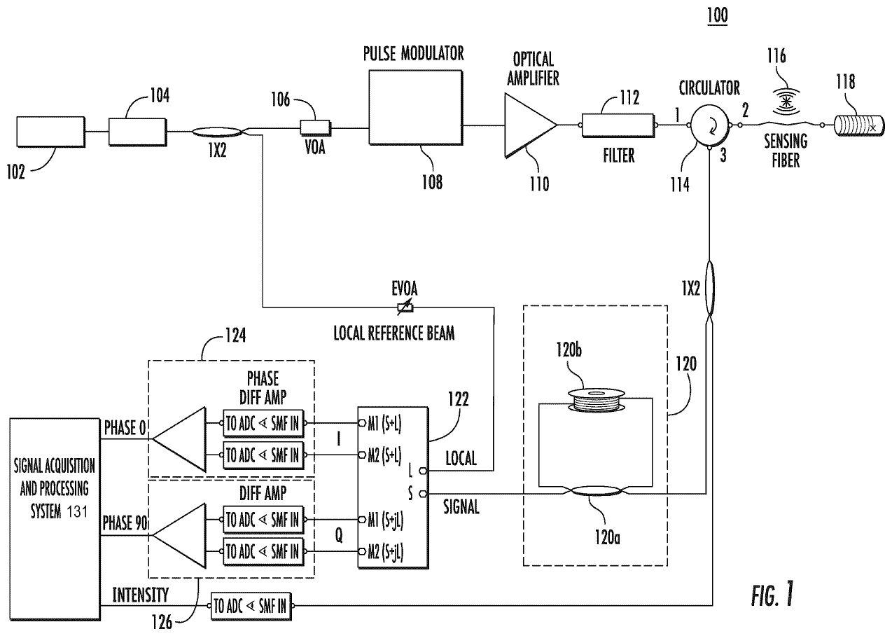

FIG. 1 is a schematic diagram illustrating an embodiment of a distributed acoustic sensing system 100, incorporating an optical interferometer 120. The distributed acoustic sensing system 100 includes a source 102, a light receiver 104, a variable optical attenuator (VOA) 106, a pulse modulator 108, an optical amplifier 110, a filter 112, an optical circulator 114, a sensing fiber 116, a dead end 118, an optical interferometer 120, a hybrid phase detection device 122, receivers 124 and 126, and a signal acquisition and processing system 128. The distributed acoustic sensing system 100 can detect structural defects, such as pipeline leaks and/or can sense changes in parameters, such as temperature or strain.

The light source 102 can generate light signals, which serve as the information carriers in the sensing operation. The light signals carry details about acoustic disturbances in the environment they traverse. Interactions with external acoustic fields can modify the propagation characteristics of the light signals, such as their intensity, phase, or polarization, forming the basis for distributed acoustic sensing. The wavelength of the light signals generated by the light source 102 can vary across embodiments. In some cases, the light source 102 is a narrowband light source, emitting a narrow range of wavelengths. In other cases, the light source 102 is a broadband light source, emitting a broader range of wavelengths. In some cases, the light source 102 is a laser or a highly-coherent optical source, such as a fiber distributed feedback laser.

The light receiver 104 can capture the light signals emitted by the light source 102 after their interaction with a portion of the environment. This reception can enable the analysis or interpretation of the light signals for the sensing operation. Depending on the application, the light receiver 104 may be an optical photodetector, a photodiode, a photoconductor, an avalanche photodetector, or a PINFet, among others.

The variable optical attenuator (VOA) 106 can regulate the power levels of the transmitted light signals. The VOA 106 can adjust the intensity of these light signals in response to factors such as variations in input power or changes in the sensing environment. In some cases, the VOA 106 can be implemented as a mechanical, liquid crystal, or acousto-optic attenuator. In some cases, the VOA 106 attenuates the light signals to desired power levels or within a selected range, preparing these signals for subsequent modulation at the pulse modulator 108.

The pulse modulator 108 can manipulate the light signals to form specific pulse shapes, which carry information for the sensing operation. The pulse modulator 108 can include, but is not limited to, a semiconductor optical amplifier, an electro-optic, an acousto-optic, or a magneto-optic modulator.

The optical amplifier 110 can boost the power of the light signals, thereby enhancing their range and detection accuracy. The optical amplifier 110 can include, but is not limited to, an erbium-doped fiber amplifier (EDFAs), a semiconductor optical amplifier (SOAs), or a Raman amplifier.

The filter 112 can transmit light signals within a certain range of wavelengths, thereby filtering out undesired frequencies and improving the system's sensitivity and signal-to-noise ratio. The filter 112 can ensure that only the desired wavelengths reach the sensing fiber 116, optimizing the signal quality for sensing operation. In some cases, the filter 112 is a band-pass filter that allows light within a specific range to pass through. In some cases, the filter 112 is a dielectric filter, an absorptive filter, or an interference filter.

The optical circulator 114 can guide light signals in a unidirectional manner, allowing the isolation of incoming and outgoing signals. This unidirectional flow can enhance system efficiency by preventing potential interference between signals moving in opposite directions. The optical circulator 114 can have varying configurations, including but not limited to, a three-port, four-port, or multi-port setup. The optical circulator 114 can facilitate the transmission of the probe pulse into the sensing fiber 116 and can redirect the returned backscatter signal to a separate path. The diverted backscatter signal can be an output of the optical circulator 114.

The sensing fiber 116, acting as a fiber-optic sensor, can use its optical fiber as the sensing medium, providing a channel for light signals to interact with the environment under investigation. The sensing fiber 116 can include, but is not limited to, a phase OTDR sensor, a Sagnac interferometer, a Michelson interferometer, a Rayleigh effect sensor, a Brillouin effect sensor, or a Raman effect sensor. In some cases, the sensing fiber 116 can create multiple distributed sensing points along its length, allowing for detailed environmental analysis.

The optical interferometer 120 is an optical device that can split, delay, and recirculate light signals to form dynamic interference patterns. These interference patterns can be characterized by alternating bright and dark fringes, representing encoded information such as the phase, path length, or anomalies encountered by the light signals. Using the interference patterns output from the optical interferometer 120, a signal acquisition and processing system 128 can analyze and decode the encoded information, providing valuable insights into the monitored environment.

In some cases, the optical interferometer 120 can be a fiber ring interferometer or a fiber ring resonator interferometer. For example, the optical interferometer 120 can utilize a looped optical fiber path to create a closed loop where light signals can be delayed and recirculated. This configuration, which can be characteristic of a fiber ring or fiber ring resonator interferometer, can enable the system to generate interference patterns that result from the interaction of recirculated light signals with new incoming signals. The delay and recirculation within the loop can enhance the sensitivity and resolution of the system, making it effective for detecting small perturbations, such as acoustic disturbances in distributed sensing applications. The use of a fiber ring structure can allow the system to progressively mitigate noise and improve signal integrity, ensuring more accurate and reliable measurements.

During operation of the optical interferometer 120, a portion of the light signals undergoes a controlled delay and is temporarily stored. As the light circulates within the ‘ring’ of the optical interferometer 120, this delay enables the stored light to interfere with subsequent incoming light signals. This process introduces multiple data sampling points over a specific time period, enhancing the resolution and accuracy of the distributed acoustic sensing system 100 in detecting and localizing acoustic events. The stored and delayed light signals within the optical interferometer 120 can help to counteract instances of signal fading, aiding in preserving signal integrity. This delay and storage feature also offers additional opportunity to detect acoustic events, potentially missed in the initial pass of the light signal, thereby enhancing reliability and precision in acoustic event detection. As the light signals circulate within the ring of the optical interferometer 120, existing noise or distortion can be progressively mitigated or nullified.

The optical interferometer 120 can include an optical fiber coupler 120a for splitting and combining optical light signals. The optical fiber coupler 120a can include, but is not limited to, a 1×2, 2×3, or 3×3 optical fiber coupler, depending on the application.

The optical interferometer 120 can include an optical fiber delay coil 120b for introducing a time delay in the transmitted signals, effectively storing them for subsequent interference with incoming light signals. The delay can be determined by the length of the coil. For example, in some cases, the coil can range from 1 m-50 m or longer, depending on the desired time delay. In some embodiments, the delay coil 120b includes optical fiber with specialized characteristics, such as a dispersion-shifted fiber or a polarization maintaining fiber, to cater to specific system requirements.

The hybrid phase detection device 122 can estimate the phase and/or amplitude of the incoming signals by employing advanced signal processing techniques to analyze the characteristics of the signals and generate outputs that exhibit phase differences. In some cases, the hybrid phase detection device 122 takes in two primary inputs: a local oscillator signal and the output of the optical interferometer 120. In some such cases, the hybrid phase detection device 122 can estimate the phase of the incoming signals by comparing the phase of the local oscillator signal with the phase of the signal received from the optical interferometer 120. Furthermore, the hybrid phase detection device 122 can calculate the phase difference between these two signals to determine the acoustic disturbances in the monitored environment. The output of the hybrid phase detection device 122 can be a representation of this phase difference, which can be further processed and analyzed to identify and localize structural defects or acoustic events with high accuracy.

In some cases, the hybrid phase detection device 122 operates as a 90° optical hybrid. This can result in the creation of four outputs, each pair of which is phase-shifted by 180°. These pairs of outputs can be processed by two balanced receivers 124, 126, thereby generating a mixed output signal composed of both in-phase (I) and quadrature (Q) components. Such a configuration can reduce or eliminate common mode noise that may arise due to local oscillator intensity fluctuations. In some cases, the optical hybrid (e.g., when combined with another hybrid and various passive optical components) can be employed to achieve polarization diversification.

In some cases, the hybrid phase detection device 122 can operate within a range of 0 to 90 degrees, allowing for varying degrees of phase shift. This can extend the system's adaptability to a broader range of operational requirements. For instance, in a 0° configuration, the outputs of the hybrid device can be merged in an analog circuit, providing a different approach to phase estimation in a homodyne OTDR system.

The hybrid phase detection device 122 can process the in-phase and quadrature components from the light signals, which can then be used to compute the phase using algorithms such as CORDIC (COordinate Rotation Digital Computer). The digitized outputs from the balanced receivers can be supplied to a signal processing device for additional operations, such as arc tangent calculations. This sequence can enable the distributed acoustic sensing system 100 to estimate the phase and amplitude with precision.

The receivers 124, 126 can convert the optical signals into electrical signals, which can then be processed and analyzed. The receivers 124, 126 can include detectors such as, but are not limited to, any combination of a photodiode, an avalanche photodiode, PINFet, or a photomultiplier tube.

The signal acquisition and processing system 128 can receive and process the output signals from the hybrid phase detection device 122 and/or the signals from the optical receivers 124, 126. The signal acquisition and processing system 128 can perform signal analysis including, but not limited to, filtering, amplification, or digitization, to extract valuable information from the received signals. The signal acquisition and processing system 128 can utilize advanced algorithms and techniques to accurately interpret the data, enabling precise detection, localization, or characterization of acoustic disturbances or structural anomalies.

As a nonlimiting example, consider the signal flow through the components of the distributed acoustic sensing system 100 in the context of a distributed acoustic sensing operation. The source 102 emits a light signal that passes through an isolator 105 and splits into two distinct pathways, labeled as paths 101 and 103. Following path 101, the signal passes through a VOA 106, controlling the signal's power level, and undergoes modification by the pulse modulator 108, resulting in the generation of a distinct probe pulse. This modulated pulse is then amplified by the optical amplifier 110 and filtered by the filter 112. The probe pulse is received by the sensing fiber 116, with signal propagation facilitated by the optical circulator 114.

As the probe pulse travels through the sensing fiber 116, it interacts with the environment, resulting in a backscatter signal. This backscatter signal returns to the optical circulator 114, which effectively isolates it from any forward-propagating light. The optical circulator 114 then redirects the backscatter signal, with one part received by the signal acquisition and processing system 128 via path 121, and the other part received by the optical interferometer 120 via path 119.

Within the optical interferometer 120, the backscatter signal undergoes further processing. The optical interferometer 120 splits, delays, and recirculates light signals, creating dynamic interference patterns that encode information about the phase, path length, or encountered anomalies of the light signals.

The hybrid phase detection device 122 receives the signal (e.g., a local oscillator signal) from path 103 and the output from the optical interferometer 120 and estimates the phase and/or amplitude of the incoming signals. For example, by comparing the phase of the local oscillator signal from path 103 with the phase of the signal received from the optical interferometer 120, the hybrid phase detection device 122 can calculate the phase difference.

The receivers 124 and 126 condition and process the electrical signals output by the hybrid phase detection device 122, generating a mixed output signal composed of both in-phase (I) and quadrature (Q) components. The signal acquisition and processing system 128 receives and processes the output signals from the receivers 124 and 126 and/or the signal from path 121. Utilizing advanced algorithms and techniques, the signal acquisition and processing system 128 performs signal analysis, including filtering, amplification, or digitization, to extract information from the received signals. This interpretation of the data can enable precise detection, localization, or characterization of acoustic disturbances or structural anomalies within the distributed acoustic sensing operation.

It will be appreciated that the distributed acoustic sensing system 100 may include fewer, more, or different components. For example, one or more of the source 102, the isolator 105, the light receiver 104, the variable optical attenuator (VOA) 106, the pulse modulator 108, the optical amplifier 110, the filter 112, the optical circulator 114, the sensing fiber 116, the optical interferometer 120, the hybrid phase detection device 122, the receivers 124, 126, or the signal acquisition and processing system 128 may be optional.

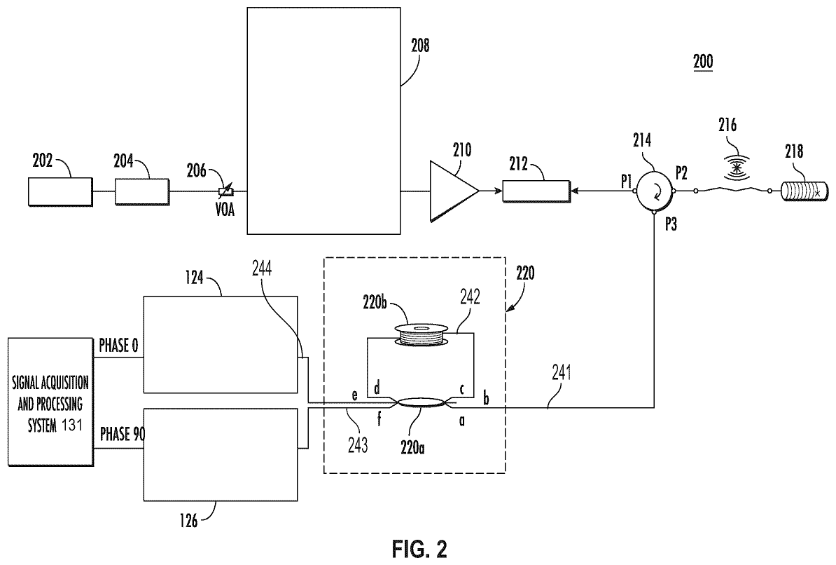

FIG. 2 is a schematic diagram illustrating an example distributed acoustic sensing system 200. The distributed acoustic sensing system 200 includes a source 202, a light receiver 204, a VOA 206, a pulse modulator 208, an optical amplifier 210, a filter 212, an optical circulator 214, a sensing fiber 218, an optical interferometer 220, receivers 224, 226, and a signal acquisition and processing system 228. The distributed acoustic sensing system 200 is an embodiment of, and can include one or more of the features of, the distributed acoustic sensing system 100 shown in FIG. 1.

As compared to the distributed acoustic sensing system 100 of FIG. 1, in this configuration, the hybrid phase detection device 122 is omitted, and the output of the optical interferometer 220 is processed by the signal acquisition and processing system 228. This configuration can simplify the signal flow by eliminating the intermediate processing step.

In the optical interferometer 220 depicted in FIG. 2, the first light signals traverse a first path 241 (or path a). This path represents the initial route of the light signals as they are transmitted through the optical fiber system. The second path 242 is defined by the loop formed by the optical fiber delay coil 220b, configured to introduce a controlled time delay. This second path includes the sections labeled paths d and c, where the light signals are delayed and stored temporarily for subsequent interference.

The optical coupler 220a within the optical interferometer 220 is configured to combine the first light signals from path 241 (or path a) with the second light signals traversing the delayed loop of the second path 242 (or paths d and c). The coupler 220a further separates these combined signals into at least the second path (loop 242, paths d and c) and a third path 243 (or path f). In some configurations, the third path could also correspond to path e, depending on the specific implementation.

The signal acquisition and processing system 131 receives the light signals from the third path 243 and determines characteristics of the acoustic disturbances based on these signals. The signal acquisition and processing system 131 analyzes the combined light signals to detect and localize acoustic events, thereby enabling precise structural monitoring and defect detection within the distributed acoustic sensing system.

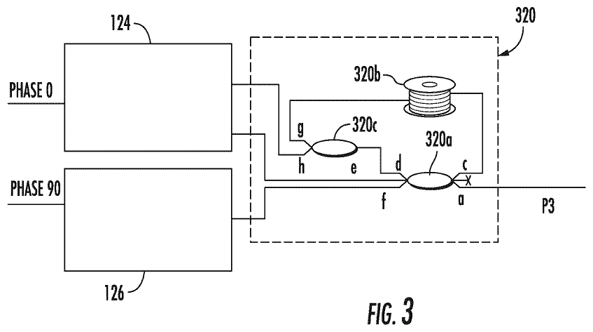

FIG. 3 is a schematic diagram that illustrates an implementation of an example optical interferometer 320. It will be understood that any of the distributed acoustic sensing systems described herein may be adapted to incorporate the optical interferometer 320 and/or the corresponding components depicted in FIG. 3.

The optical interferometer 320 includes a first coupler 320a, a delay coil 320b, and a second coupler 320c. In comparison to the optical interferometer 120 of FIG. 1, the optical interferometer 320 includes the additional second coupler 320c to provide an additional output 128. The first coupler 320a and the delay coil 320b may be the same as the coupler 120a and the delay coil 120b, respectively, of FIG. 1.

In the configuration depicted in FIG. 3, the second coupler 320c is a 1×2 coupler, and the mixed light signals output from path d of the first coupler 320a are transmitted to the second coupler 320c, which splits the mixed light signals output from path d to paths g and h. The signals from path g can be provided as feedback to the delay coil 320b for generating delay signals. The delay signals can be combined with subsequent incoming light signals input from path a of the first coupler 320a. The mixed signals output from paths e, f, and h may be transmitted to one or more optical components 124, 126, and 128 for further processing, such as amplifiers, Analog-Digital-Converters (ADC), etc.

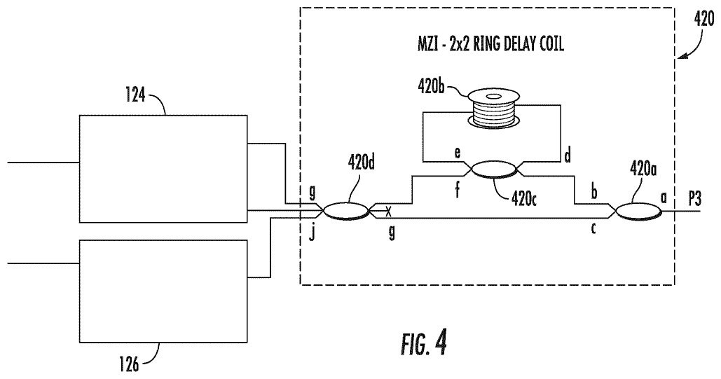

FIG. 4 is a schematic diagram that illustrates an implementation of an example optical interferometer 420. It will be understood that any of the distributed acoustic sensing systems described herein may be adapted to incorporate the optical interferometer 420 and/or the corresponding components depicted in FIG. 4. The optical interferometer 420 includes a first coupler 420a, a delay coil 420b, a second coupler 420c, and a third coupler 420d. The first coupler 420a may be a 1×2 coupler, the second coupler 420c may be a 2×2 coupler, and the third coupler 420d may be a 3×3 coupler to provide three channel outputs g, i, j.

In the configuration depicted in FIG. 4, the sensed light signals from port P3 are input to the path a of the first coupler 420a. The first coupler 420a splits the power of the light signals two ways and outputs to paths b and c, with the phase shifts, such as, 0°, 180°, respectively. The light signals output from path b of the first coupler 420a are transmitted to the second coupler 420c. The second coupler 420c combines or mixes the input sensed light signals from path b with the delayed previously sensed light signals from path d. The power of the mixed light signals are split to two ways and output to paths e, f. The mixed light signals output from path e of the second coupler 420c are transmitted to the delay coil 420b to generate delay signals for combining with subsequent light signals input from path b of the first coupler 420a. The third coupler 420d mixes signals output from path c of the first coupler 420a with the signals output from path f of the second coupler 420c and generate three channel outputs g, i, j for further processing.

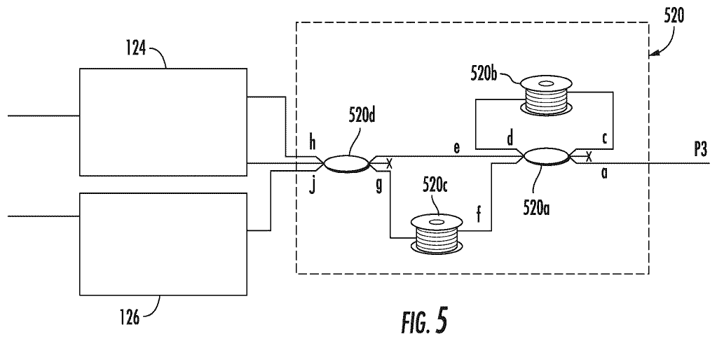

FIG. 5 is a schematic diagram that illustrates an implementation of an example optical interferometer 520. It will be understood that any of the distributed acoustic sensing systems described herein may be adapted to incorporate the optical interferometer 520 and/or the corresponding components depicted in FIG. 5. The optical interferometer 520 includes a first coupler 520a, a first delay coil 520b, a second coupler 520c, and a second delay coil 520d. The first coupler 520a may be a 3×3 coupler and the second coupler 520c may be a 3×3 coupler to provide three channel outputs h, i, j. One or both of the first delay coil 520b and the second delay coil 520d may be the same as or similar to the delay coil 120b of FIG. 1.

In the configuration depicted in FIG. 5, the sensed light signals from port P3 are input to the path a of the first coupler 520a. The first coupler 520a splits the power of the light signals three ways and outputs to paths d, e, and f. The light signals output from path d of the first coupler 520a are transmitted to the first delay coil 520b. The first coupler 520a combines or mixes the input sensed light signals from path a with the delayed previously sensed light signals from path c. The light signals output from path e of the first coupler 520a are transmitted to the second coupler 520d. The light signals output from path f of the first coupler 520a are transmitted to the second delay coil 520c to generate further delay signals. The second coupler 520d combines and mixes the light signals output from path e of the first coupler 520a and the further delay signals from output from path g of the second coupler 520c. The power of the mixed light signals are split to h, i, and j for further processing.

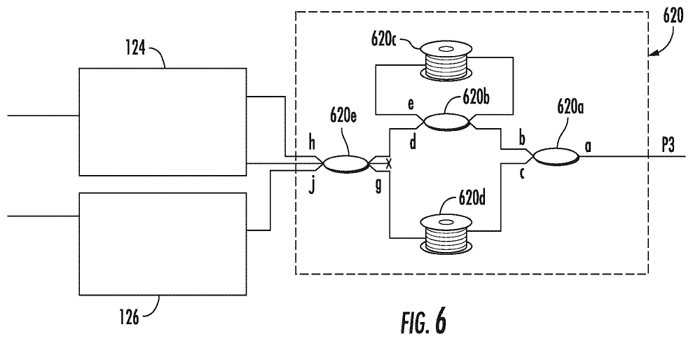

FIG. 6 is a schematic diagram that illustrates an implementation of an example optical interferometer 620. It will be understood that any of the distributed acoustic sensing systems described herein may be adapted to incorporate the optical interferometer 620 and/or the corresponding components depicted in FIG. 6. The optical interferometer 620 includes a first coupler 620a, a second coupler 620b, a first delay coil 620c, a second delay coil 620d, and a third coupler 620c. The first coupler 620a may be a 1×2 coupler, the second coupler 620b may be a 2×2 coupler, and the third coupler 620e may be a 3×3 coupler to provide three channel outputs h, i, j. One or both of the first delay coil 620c and the second delay coil 620d may be the same as or similar to the delay coil 120b of FIG. 1.

In the configuration depicted in FIG. 6, the sensed light signals from port P3 are input to the path a of the first coupler 620a. The first coupler 620a splits the power of the light signals two ways and outputs to paths b and c. The light signals output from path b of the first coupler 620a are transmitted to the second coupler 620b. The second coupler 620b combines or mixes the input sensed light signals from path b with the delayed previously sensed light signals from path f output from the first delay coil 620c. The light signals output from path e of the second coupler 620b are transmitted to the delay coil 620c for generating further delay signals. The light signals output from path d of the first coupler 620a are transmitted to the third coupler 620e. The light signals output from path c of the first coupler 620a are transmitted to the second delay coil 620d to generate further delay signals. The delay coils 620c and 620d may generate same or different time delays in the delayed light signals. The third coupler 620e combines or mixes the input sensed light signals from path d of the second coupler 620b with the delayed previously sensed light signals from path g of the second delay coil 620d. The power of the mixed light signals are split to h, i, and j for further processing.

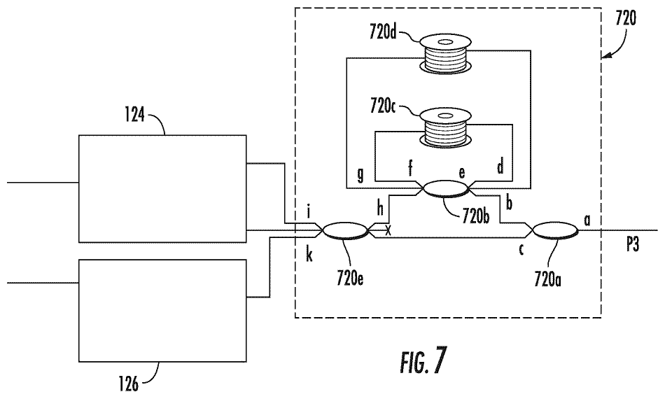

FIG. 7 is a schematic diagram that illustrates an implementation of an example optical interferometer 720. It will be understood that any of the distributed acoustic sensing systems described herein may be adapted to incorporate the optical interferometer 720 and/or the corresponding components depicted in FIG. 7. The optical interferometer 720 includes a first coupler 720a, a second coupler 720b, a first delay coil 720c, a second delay coil 720d, and a third coupler 720e. The first coupler 720a may be a 1×2 coupler, the second coupler 720b may be a 3×3 coupler, and the third coupler 720e may be a 3×3 coupler to provide three channel outputs i, j, k. One or both of the first delay coil 720c and the second delay coil 720d may be the same as or similar to the delay coil 120b of FIG. 1.

In the configuration depicted in FIG. 7, the sensed light signals from port P3 are input to the path a of the first coupler 720a. The first coupler 720a splits the power of the light signals to two ways and output to paths b and c. The light signals output from path b of the first coupler 720a are transmitted to the second coupler 720b. The second coupler 720b combines or mixes the input sensed light signals from path b with the delayed previously sensed light signals from paths d and e respectively output from the first and second delay coils 720c and 720d. The light signals output from path f of the second coupler 720b are transmitted to the first delay coil 720c for generating further delay signals. The light signals output from path g of the second coupler 720b are transmitted to the second delay coil 720d for generating further delay signals. The first and second delay coils 720c and 720d may generate same or different time delays in the delayed light signals. The light signals output from path h of the second coupler 720b and the light signals output from path c of the first coupler 720a are transmitted to the third coupler 720e. The third coupler 720c combines or mixes the input sensed light signals from paths h and c and split the signals to output paths i, j and k for further processing.

FIG. 8 is a schematic diagram that illustrates an implementation of an example optical interferometer 820. It will be understood that any of the distributed acoustic sensing systems described herein may be adapted to incorporate the optical interferometer 820 and/or the corresponding components depicted in FIG. 8. The optical interferometer 820 includes a first coupler 820a, a second coupler 820b, a first delay coil 820c, a second delay coil 820d, and a third coupler 820c. The first coupler 820a may be a 3×3 coupler, the second coupler 820b may be a 3×3 coupler, and the third coupler 820c may be a 3×3 coupler to provide three channel outputs j, k, l. One or both of the first delay coil 820c and the second delay coil 820d may be the same as or similar to the delay coil 120b of FIG. 1.

In the configuration depicted in FIG. 8, the sensed light signals from port P3 are input to the path a of the first coupler 820a. The first coupler 820a splits the power of the light signals three ways and outputs to paths b, c, and d. The signals output from the path c is output for further processing. The light signals output from path b of the first coupler 820a are transmitted to the second coupler 820b. The second coupler 820b combines or mixes the input sensed light signals from path b with the delayed previously sensed light signals from paths f and e respectively output from the first and second delay coils 820c and 820d. The light signals output from path g of the second coupler 820b are transmitted to the first delay coil 820c for generating further delay signals. The light signals output from path h of the second coupler 820b are transmitted to the first delay coil 820d for generating further delay signals. The delay coils 820c and 820d may generate same or different time delays in the delayed light signals. The light signals output from path i of the second coupler 820b and the light signals output from path d of the first coupler 820a are transmitted to the third coupler 820c. The third coupler 820e combines or mixes the input sensed light signals from paths i and d and split the signals to output paths j, k, and l for further processing.

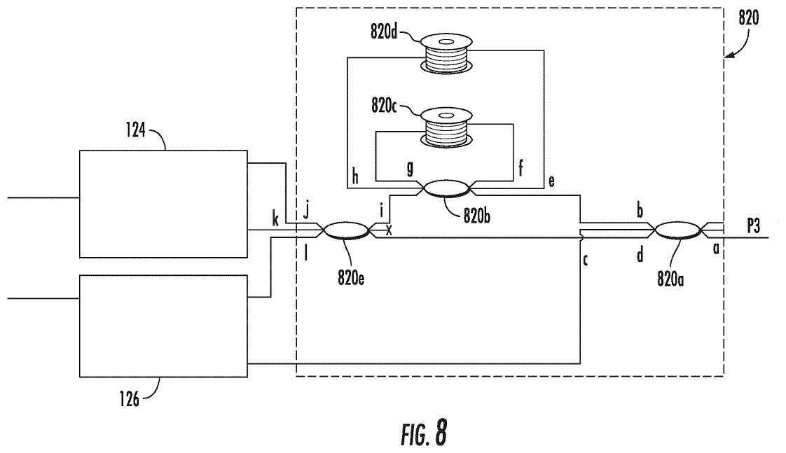

FIG. 9 is a schematic diagram that illustrates an implementation of an example optical interferometer 920. It will be understood that any of the distributed acoustic sensing systems described herein may be adapted to incorporate the optical interferometer 920 and/or the corresponding components depicted in FIG. 9.

The optical interferometer 920 includes a first coupler 920a, a second coupler 920b, a first delay coil 920c, a second delay coil 920c, and a third coupler 920d. The first coupler 920a may be a 1×2 coupler, the second coupler 920b may be a 2×2 coupler, and the third coupler 920d may be a 3×3 coupler to provide two channel outputs i and j. One or both of the first delay coil 920c and the second delay coil 920e may be the same as or similar to the delay coil 120b of FIG. 1.

In the configuration depicted in FIG. 9, the sensed light signals from port P3 are input to the path a of the first coupler 920a. The first coupler 920a splits the power of the light signals into two ways and output to paths b and c. The light signals output from path b of the first coupler 920a are transmitted to the second coupler 920b. The second coupler 920b combines or mixes the input sensed light signals from path b with the delayed previously sensed light signals from path d output from the first delay coil 920c. The light signals output from path e of the second coupler 920b are transmitted to the first delay coil 920c for generating further delay signals. The second coupler 920b combines or mixes the input sensed light signals from paths c of the first coupler 920a and f of the second coupler 920b with the delayed previously sensed light signals from path g output from the second delay coil 920e. The light signals output from path h of the third coupler 920d are transmitted to the second delay coil 920e for generating further delay signals. The first and second delay coils 920c and 920c may generate same or different time delays in the delayed light signals. The light signals output from paths i and j of the third coupler 920d for further processing.

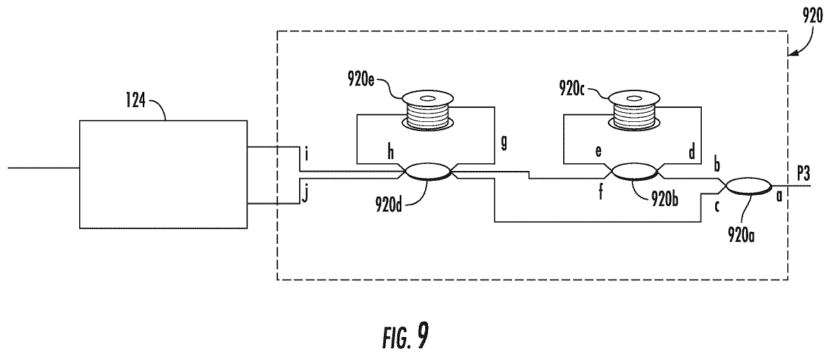

FIG. 10 is a schematic diagram that illustrates an implementation of an example optical interferometer 1020. It will be understood that any of the distributed acoustic sensing systems described herein may be adapted to incorporate the optical interferometer 1020 and/or the corresponding components depicted in FIG. 10.

The optical interferometer 1020 includes a first coupler 1020a, a second coupler 1020c, a delay coil 1020d, filters 1020b and 1020e for filtering the noise outside the selected frequency band, and a light source 1020f for generating light signals. The first coupler 1020a may be a 3×3 coupler and the second coupler 1020c may be a 1×2 coupler to provide two channel outputs c and d. The delay coil 1020d may be the same as or similar to the delay coil 120b of FIG. 1.

In the configuration depicted in FIG. 10, the sensed light signals from port P3 are input to the path a of the first coupler 1020a. The first coupler 1020a splits the power of the light signals three ways and outputs to paths b, c and d. The light signals output from path b from the first coupler 1020a are transmitted to the first filter 1020b for filtering the noise outside the selected light spectrum. The signals output from the first filter 1020b is input to the second coupler 1020c. The second coupler 1020c combines or mixes the input sensed light signals from the first filter 1020b with the additional light source 1020f and general output signals at path g. The light signals output from path g of the second coupler 1020c are transmitted to the delay coil 1020d for generating further delay signals. The delay signals output from path h of the delayed coil 1020d are filtered at the second filter 1020e for filtering the noise outside the selected light spectrum, and output from path c. The first coupler 1020a combines the filtered delay signals from path e with the sensed signals from path a and splits the combined signals into three ways and output to paths b, c, and d. The light signals output from paths c and d of the first coupler 1020a are output for further processing.

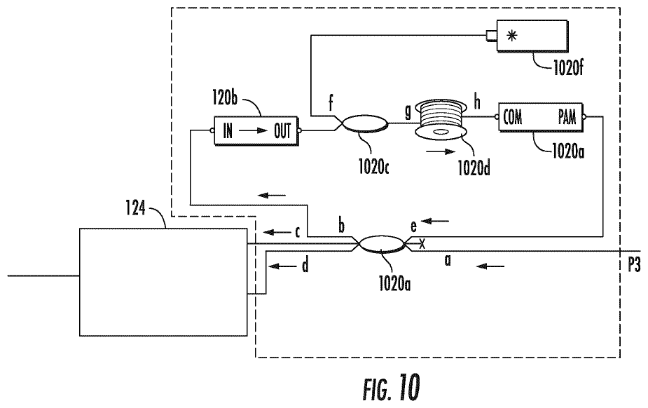

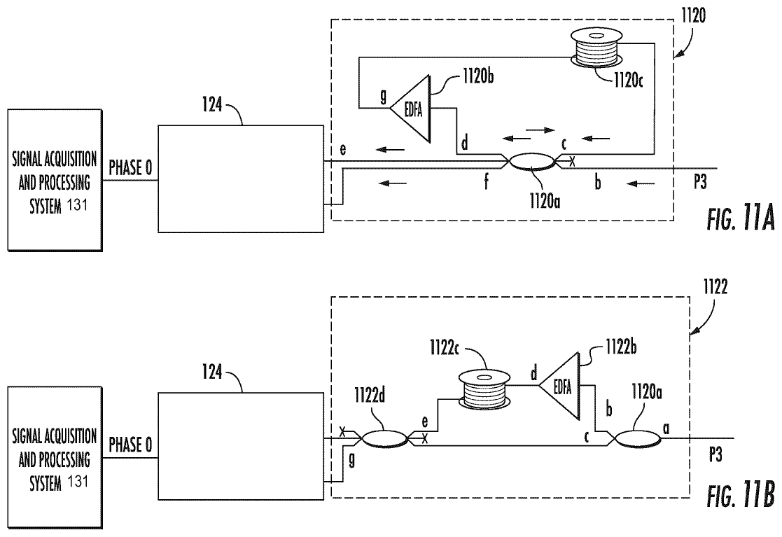

FIG. 11A is a schematic diagram that illustrates an implementation of an example optical interferometer 1120. It will be understood that any of the distributed acoustic sensing systems described herein may be adapted to incorporate the optical interferometer 1120 and/or the corresponding components depicted in FIG. 11A.

The optical interferometer 1120 includes a coupler 1120a, a delay coil 1120c, and an amplifier 1120b. The coupler 1120a may be a 1×2 coupler. The delay coil 1120c may be the same as or similar to the delay coil 120b of FIG. 1. As compared to the distributed acoustic sensing system 100 of FIG. 1, in this configuration, the optical interferometer 1120 includes an additional amplifier 1120d to amplify the signals output from the coupler 1120a.

In the configuration depicted in FIG. 11A, the sensed light signals from port P3 are input to the path a of the coupler 1120a. The coupler 1120a combines or mixes the input sensed light signals from path a with the delayed previously sensed light signals from path c. The power of the mixed light signals are split to three ways and output to paths d, e, f. The mixed light signals output from path d of the coupler 1120a are transmitted to the amplifier 1120b for amplifying. The amplified signals output from the amplifier 1120b are input to the delay coil 1120c via the path g to generate delay signals for combining with subsequent light signals input from path a of the coupler 1120a. The mixed signals output from paths e and f are output for further processing.

FIG. 11B is a schematic diagram that illustrates an implementation of an example optical interferometer 1122. It will be understood that any of the distributed acoustic sensing systems described herein may be adapted to incorporate the optical interferometer 1122 and/or the corresponding components depicted in FIG. 11B.

The optical interferometer 1122 includes a first coupler 1122a, a second coupler 1122d, a delay coil 1122c, and an amplifier 1122b. The first coupler 1122a may be a 1×2 coupler and the second coupler 1122d may be a 2×2 coupler. The delay coil 1122c may be the same as or similar to the delay coil 120b of FIG. 1.

In the configuration depicted in FIG. 11B, the sensed light signals from port P3 are input to the path a of the first coupler 1122a. The first coupler 1122a split the power of the signals to two ways and output to paths b and c. The light signals output from path b of the first coupler 1122a are transmitted to the amplifier 1122b for amplifying. The amplified signals output from the amplifier 1122b are input to the delay coil 1122c via the path d to generate delay signals. The delay signals output from the delay coil 1122c are input to the second coupler 1122d. The second coupler 1122d combines the delay signals from the path e with the sensed signals from path c. The mixed signals output from paths e and f may be output channels for further processing.

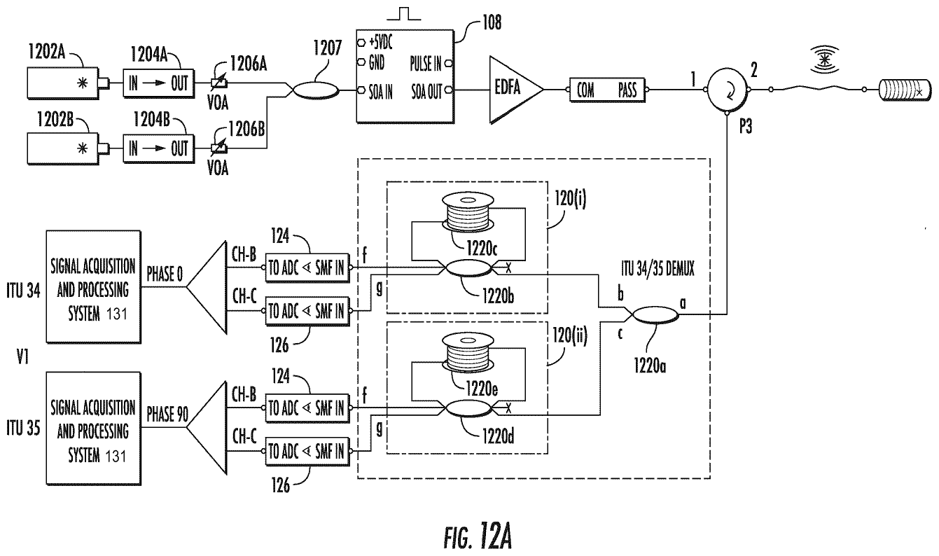

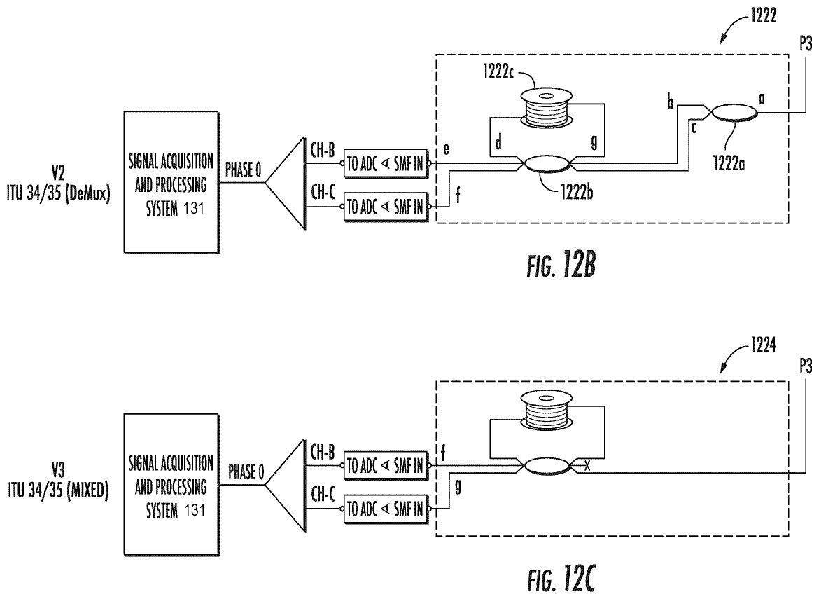

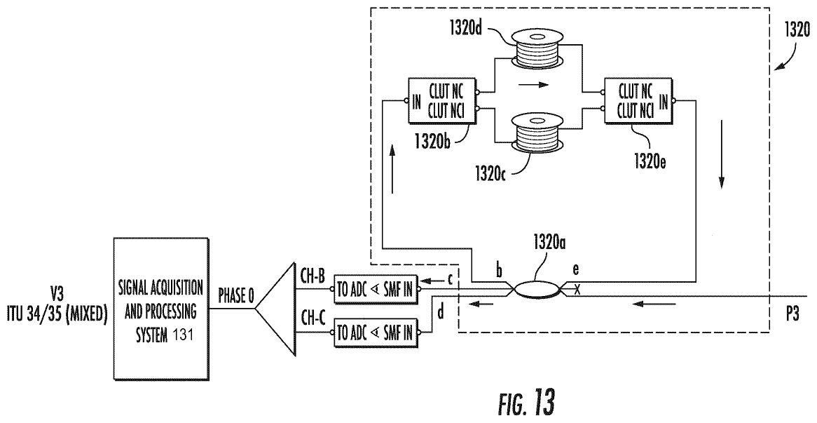

FIG. 12A is a schematic diagram illustrating an example distributed acoustic sensing system 1200 that includes an example optical interferometer 1220. It will be understood that any of the distributed acoustic sensing systems described herein may be adapted to incorporate the optical interferometer 1220 and/or the corresponding components depicted in FIG. 12A.

The distributed acoustic sensing system 1200 includes two sets of light sources 102A and 102b, light receivers 104A and 104b, variable optical attenuators 106A and 106B, and an optical interferometer 1220. The optical interferometer 1220 includes a first coupler 1220a, a second coupler 1220b, a third coupler 1220d, a first delay coil 1220c, and a second delay coil 1220c. The first coupler 1220a may be a 1×2 coupler, the second coupler 1220b may be a 3×3 coupler, and the third coupler 1220d may be a 3×3 coupler. One or both of the first delay coil 1220c and the second delay coil 1220e may be the same as or similar to the delay coil 120b of FIG. 1.

The first set (e.g., light source 1202A, light receiver 1204A, and variable optical attenuator 106A) is configured to process the ITU 34 or 35 NLL signals. The second set (e.g., light source 1202b, light receiver 1204b, and variable optical attenuator 1206B) is configured to process the ITU 34/35 NLL signals. Each of the first and second sets can operate in the same or a similar manner as light source 102, light receiver 104, variable optical attenuator 106 of the system 100 in FIG. 1. The signals output from 106A and 106B can be combined as ITU 34 and 35 NLL signals at a coupler 107 that can function as a mux. The combined ITU 34 and 35 NLL signals can be processed in the modulator 108.

The optical interferometer 1220 includes a first 1×2 coupler 1220a as a demux for splitting the combined ITU 34/35 NLL signals to ITU 34 NLL signals and ITU 35 NLL signals. The sensed signals from port P3 are input to the path a of the first coupler 1220a. The first coupler 1220a splits the sensed signals two ways b transmitting ITU 34 NLL signals and c transmitting ITU 35 NLL signals. The second coupler 1220b and the first delay coil 1220c form the optical interferometer 1220i for outputting ITU 34 NLL signals, the third coupler 1220d and the second delay coil 1220e form the optical interferometer 1220ii for outputting ITU 35 NLL signals.

FIG. 12B is a schematic diagram that illustrates an implementation of an example optical interferometer 1222. It will be understood that any of the distributed acoustic sensing systems described herein may be adapted to incorporate the optical interferometer 1222 and/or the corresponding components depicted in FIG. 12B.

The optical interferometer 1222 includes a first coupler 1222a, a second coupler 1222b, and a delay coil 1222c. The first coupler 1222a may be a 1×2 coupler and the second coupler 1222b may be a 3×3 coupler. The delay coil 1222c may be the same as or similar to the delay coil 120b of FIG. 1.

In the configuration depicted in FIG. 12B, the first coupler 1220a can act a demux for splitting combined ITU 34/35 NLL signals. The sensed signals from port P3 are input to the path a of the first coupler 1220a. The first coupler 1220a splits the sensed signals into two ways b and c for selectively transmitting separate ITU 34 NLL signals or ITU 35 NLL signals. The second coupler 1222b combines or mixes the input sensed light signals from paths b and c with the delayed previously sensed light signals from path g. The power of the mixed light signals are split to three ways and output to paths d, e, f, with the phase shifts. The mixed light signals output from path d of the second coupler 1222b are transmitted to the delay coil 1222c to generate delay signals for combining with subsequent light signals input from paths b and c of the first coupler 1222a. The mixed signals output from paths e and f may be output for further processing. The signals transmitted on paths e and f may be ITU 34 NLL signals or ITU 34 NLL signals.

FIG. 12C is a schematic diagram that illustrates an implementation of an example optical interferometer 1224. As compared to the optical interferometer 120 of FIG. 1, in this configuration, the signals transmitted on paths e and f may be combined ITU 34/35 NLL signals.

FIG. 13 is a schematic diagram that illustrates an implementation of an example optical interferometer 1320. It will be understood that any of the distributed acoustic sensing systems described herein may be adapted to incorporate the optical interferometer 1320 and/or the corresponding components depicted in FIG. 13.

The optical interferometer 1320 includes a coupler 1320a, a first delay coil 1320c, a second delay coil 1320d, and two 1 of N fiberoptic Switches 1320b, 1320c. The coupler 1320a may be a 3×3 coupler. One or both of the first delay coil 1320c and the second delay coil 1320d may be the same as or similar to the delay coil 120b of FIG. 1.

In the configuration depicted in FIG. 13, the sensed light signals from port P3 are input to the path a of the coupler 1320a. The coupler 1020a combines or mixes the input sensed light signals from path a with the delayed previously sensed light signals from path e. The mixed light signals output from path b of the coupler 1320a are transmitted to a 1 of N fiberoptic Switch 1320b for selecting one of the delay coils 1320c and 1320d. The delay coil 1320c or 1320d generated different time delays. The signals delayed by the delay coil 1020d or 1320d are transmitted to path e via the 1 of N fiberoptic Switch 1320c. The 1 of N fiberoptic Switches 1320b and 1320e are configured to control the direction of the light signals or change states between transmitting and cutting off the light signals. The 1 of N fiberoptic Switches 1320b and 1320e are configured to concurrently switch to connect to either delay coil 1320d or 1320c. The signals output from paths c and d may be transmitted to output channels for further processing. The optical interferometer 1320 allows to selectively generate different time delays in the output signals c.

### FIG. 12B

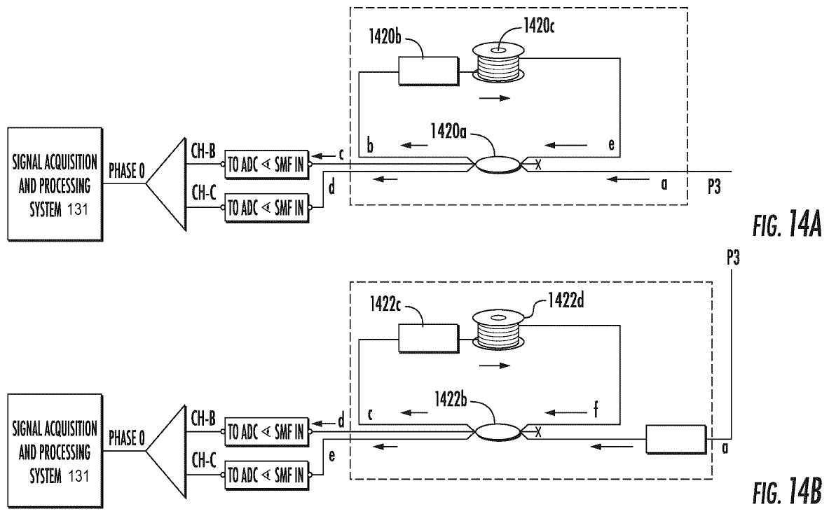

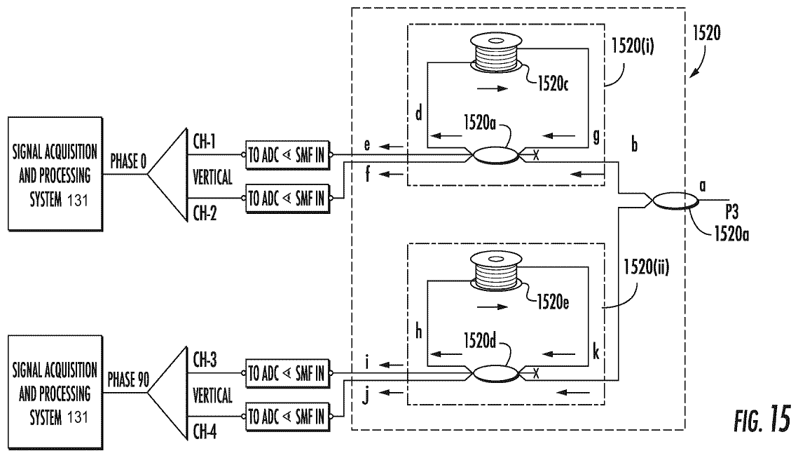

FIG. 14A is a schematic diagram that illustrates an implementation of an example optical interferometer 1420. It will be understood that any of the distributed acoustic sensing systems described herein may be adapted to incorporate the optical interferometer 1420 and/or the corresponding components depicted in FIG. 14. As compared to the distributed acoustic sensing system 100 of FIG. 1, in this configuration, the optical interferometer 1120 includes a depolarizer 1420.

The optical interferometer 1420 includes a coupler 1420a, a delay coil 1420c, and a depolarizer 1420b. The coupler 1420a may be a 3×3 coupler. The delay coil 1420c may be the same as or similar to the delay coil 120b of FIG. 1. In some cases, the depolarizer 1420b may be replaced or supplemented with a polarization scrambler.

In the configuration depicted in FIG. 14A, sensed light signals from path a with the delayed previously sensed light signals from path e. The power of the mixed light signals are split to three ways and output to paths b, c, and d. The mixed light signals output from path b of the coupler 1420a are transmitted to the depolarizer 1420b, which is configured to provide pseudo-random polarization output signals from polarized input signals from path b. The depolarized signals output from the depolarizer 1420b are input to the delay coil 1420c to generate delay signals for combining with subsequent light signals input from path a of the coupler 1420a. The mixed signals output from paths c and d may be transmitted for further processing.

FIG. 14B is a schematic diagram that illustrates an implementation of an example optical interferometer 1422. It will be understood that any of the distributed acoustic sensing systems described herein may be adapted to incorporate the optical interferometer 1422 and/or the corresponding components depicted in FIG. 14. As compared to the distributed acoustic sensing system 100 of FIG. 1, in this configuration, the optical interferometer 1120 includes two depolarizers 1422a and 1422c.

The optical interferometer 1422 includes a coupler 1422b, a delay coil 1422d, a depolarizer 1422a, and a depolarizer 1422c. The coupler 1422b may be a 3×3 coupler. The delay coil 1422d may be the same as or similar to the delay coil 120b of FIG. 1.

In the configuration depicted in FIG. 14B, the depolarizer 1422a depolarized the sensed light signals from path a. The depolarized signals are input to path b of the coupler 1422b for mixing or combining with the delayed previously sensed light signals from path f. The power of the mixed light signals are split to three ways and output to paths c, d, and e. The mixed light signals output from path c of the coupler 1422b are transmitted to the depolarizer 1422c for pseudo-random polarization output signals from polarized input signals from path c. The signals output from the depolarizer 1422c are transmitted to the delay coil 1422d to generate delay signals for combining with subsequent light signals input from path b of the coupler 1422b. The mixed signals output from paths d and e may be output for further processing.

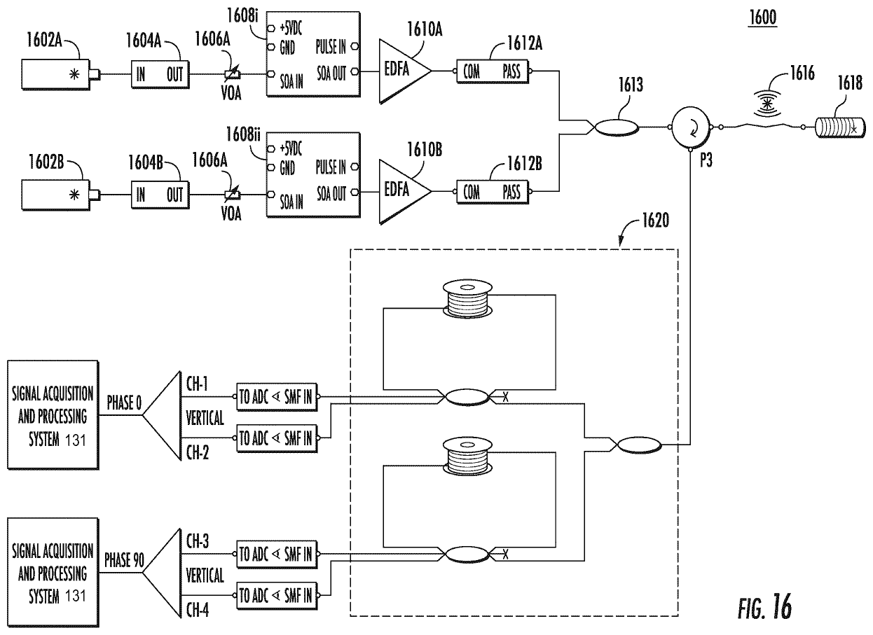

FIG. 15 is a schematic diagram that illustrates an implementation of an example optical interferometer 1520. It will be understood that any of the distributed acoustic sensing systems described herein may be adapted to incorporate the optical interferometer 1520 and/or the corresponding components depicted in FIG. 15.

The optical interferometer 1520 includes a first coupler 1520a, a second coupler 1520b, a third coupler 1520b, a first delay coil 1520c, a second delay coil 1520e. The first coupler 1520a may be a 1×2 coupler, the second coupler 1520b may be a 3×3 coupler, and the third coupler 1520d may be a 3×3 coupler. One or both of the first delay coil 1520c and the second delay coil 1520c may be the same as or similar to the delay coil 120b of FIG. 1.

In the configuration depicted in FIG. 15, the sensed signals from port P3 are input to the path a of the coupler 1520a. The optical interferometer 1220 includes a 1×2 coupler 1520a as a polarization state splitter. The coupler 1520a is configured to split the sensed signals to vertically polarized signals and horizontally polarized signals. The coupler 1520a outputs from path b the vertically polarized signals and outputs from path c horizontally polarized signals. The coupler 1520b and the delay coil 1520c form the optical interferometer 1520 (i) for processing the vertically polarized signals from path b in the same manner as the optical interferometer 120 described in FIG. 1; the coupler 1520d and the delay coil 1520e form the optical interferometer 1520 (ii) for processing the horizontally polarized signals from path c in the same manner as the optical interferometer 120. The optical interferometer 1520 (i) outputs vertically polarized signals from paths e and f. The optical interferometer 1520 (ii) outputs horizontally polarized signals from paths i and j.

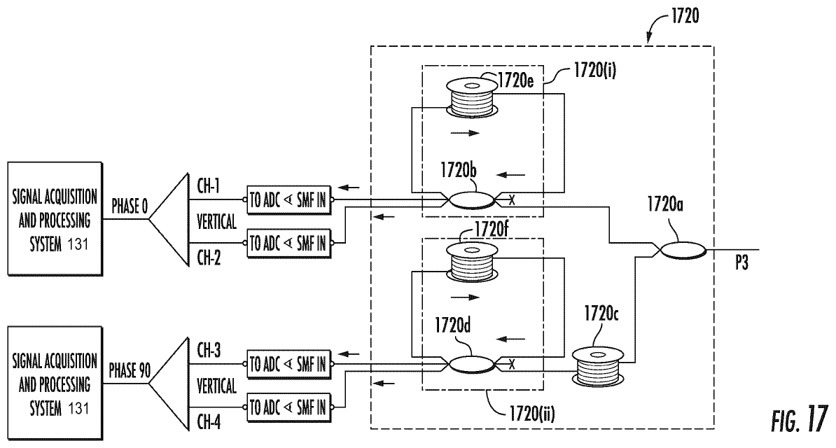

FIG. 16 is a schematic diagram illustrating an example distributed acoustic sensing system 1600 that includes an example optical interferometer 1620. It will be understood that any of the distributed acoustic sensing systems described herein may be adapted to incorporate the optical interferometer 1620 and/or the corresponding components depicted in FIG. 16.

In the configuration depicted in FIG. 16, similar to FIG. 12A, the system 1600 includes two sets of light sources 1602A and 1602b, light receivers 1604A and 1604b, variable optical attenuators 1606A and 1606B, pulse modulators 1608i and 1608ii, optical amplifiers 16160A and 16160B, and two filters 1612A and 1612B. The first set of light source 1602A, light receiver 1604A, variable optical attenuator 1606A, pulse modulator 1608i, optical amplifier 16160A, and filter 1612A are configured to process the ITU 34 NLL signals. The second set of light source 1602b, light receiver 1604b, variable optical attenuator 1606B, pulse modulator 1608ii, optical amplifier 16160B, and filter 1612B are configured to process the ITU 35 NLL signals. Each of the first and second sets operates in the same manner as light source 1602, light receiver 1604, variable optical attenuator 1606, pulse modulator 1608, optical amplifier 16160, and filter 1612 as described in system 1600 in FIG. 1. The signals output from the filter 1612A and 1612B are combined at the coupler 1613, which functions as a ITU34/35 MUX. The combined ITU 34 and 35 NLL signals are output to the optical circulator 1614, in the same manner as described in FIG. 1.

The system 1600 includes an optical interferometer 1620. The optical interferometer 1620 is the same as the optical interferometer 1120 as described in FIG. 11A.

FIG. 17 is a schematic diagram that illustrates an implementation of an example optical interferometer 1720. It will be understood that any of the distributed acoustic sensing systems described herein may be adapted to incorporate the optical interferometer 1720 and/or the corresponding components depicted in FIG. 17.

The optical interferometer 1720 includes a first coupler 1720a, a second coupler 1720b, a third coupler 1720d, a first delay coil 1720c, a second delay coil 1720e, and a third delay coil 1720f.

The sensed signals from port P3 are input to the path a of the coupler 1720a. The coupler 1720a is configured to split the sensed signals to two way signals. The coupler 1720a outputs from paths b and c. The signals from path b are input to the optical interferometer 1720 (i) in the same manner as the optical interferometer 120 described in FIG. 1; the signals from path c are input to the pre-delay coil 1720c for generating a pre-delay of time in the signals input from path c. The pre-delay signals are input to the optical interferometer 1720 (ii) for processing in the same manner as the optical interferometer 120 described in FIG. 1.

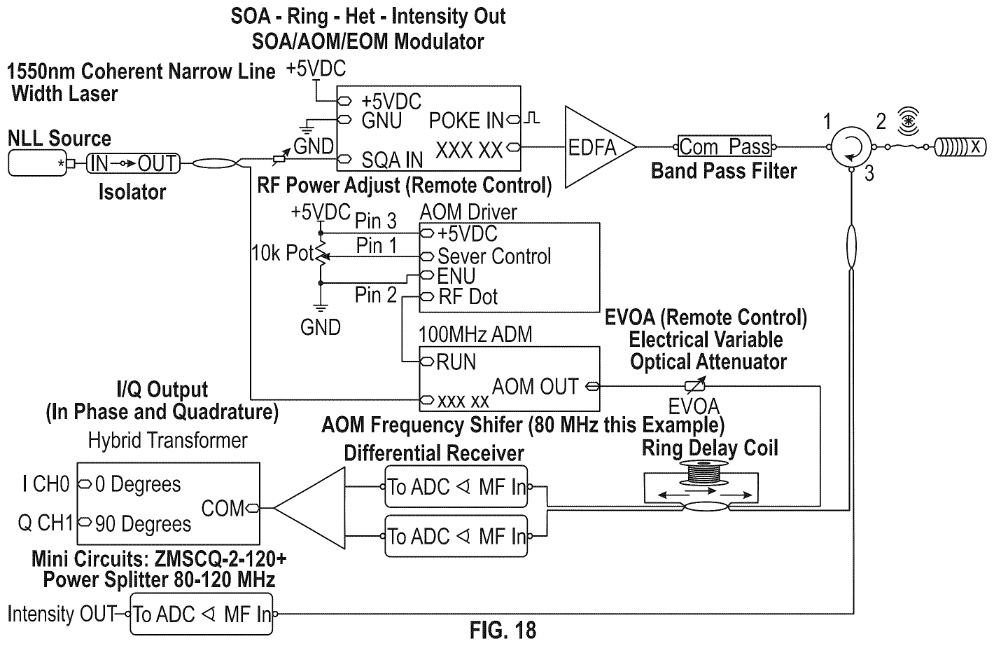

FIG. 18 is a schematic diagram illustrating an embodiment of a distributed acoustic sensing system in a heterodyne configuration, incorporating an optical interferometer. In this configuration, a reference laser signal, often referred to as a local oscillator signal, is mixed with the optical signal received from the sensing fiber within the optical interferometer. The optical interferometer includes components such as an optical fiber coupler and an optical fiber delay coil, which facilitate the controlled delay and temporary storage of the light signals. It will be understood that any of the distributed acoustic sensing systems described herein may be adapted to a heterodyne configuration.

In some cases, a heterodyne configuration refers to a method of signal processing where two different signals are combined or mixed to create new frequency components. In the context of a distributed acoustic sensing system that incorporates an optical interferometer, the heterodyne configuration can include mixing a signal from the system (such as the signal received from the sensing fiber) with a reference signal (often called a local oscillator signal). This process can enable the system to shift the signal into a different frequency range, enhancing sensitivity and providing precise information about the phase and amplitude of the optical signal. This contributes to the system's ability to detect and characterize various phenomena in the monitored environment with improved accuracy and reliability.

### Example Comb Generator

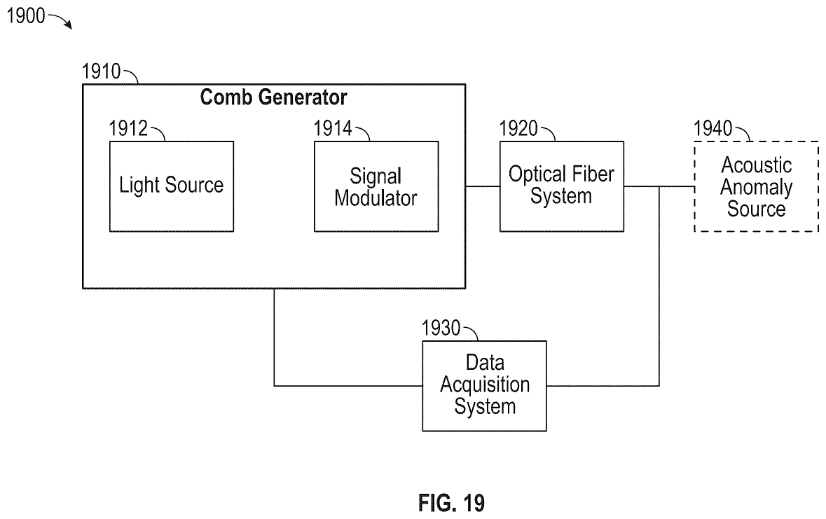

FIG. 19 is a schematic diagram illustrating an embodiment of a distributed acoustic anomaly locator system 1900 that includes an optical frequency comb generator 1910, according to some aspect of the inventive concepts. The distributed acoustic anomaly locator system 1900 includes a comb generator 1910, an optical fiber system 1920, a data acquisition system 1930, and an acoustic anomaly source 1940.

The comb generator 1910 can include a light source 1912 and a signal modulator 1914. The light source 1912 can generate a light signal to be sent to the signal modulator 1914 to produce an optical frequency comb. The implementation of the light source 1912 can vary across embodiments. In some cases, the light signal can be a coherent light signal. For example, in some cases, the light source 1912 can be a continuous wave (CW) laser configured to generate a continuous, coherent light beam. As another example, the light source 1912 can be a pulsed laser configured to emit light in short bursts. In some cases, the light source 1912 can be a tunable laser configured to adjust its wavelength based on specific requirements. The light source 1912 can be selected based on specific requirements such as signal strength, coherence properties, and/or the intended application.

The signal modulator 1914 can modulate the light signal generated by the light source 1912 to produce an optical frequency comb. The implementation of the signal modulator 1914 can vary across embodiments. In some cases, the signal modulator 1914 can use modulation techniques such as frequency modulation (FM). These modulation techniques can result in multiple frequency sidebands, which can improve the signal-to-noise ratio of the system 1900 and reduce susceptibility to interference fading.

The signal modulator 1914 can introduce phase shifts in the light signal for specific modulation patterns. The choice of modulation pattern can influence the characteristics of the optical frequency comb. For instance, in some cases, the modulation pattern can be a square wave, which can increase the density of the optical frequency comb compared to sine wave modulation. Square wave modulation can generate sidebands that are spaced more closely together, providing a denser comb structure compared to the typically wider spacing seen with sine wave modulation. In some cases, the modulation pattern can be a sawtooth or triangle wave, each creating specific harmonic characteristics in the output signal. For example, sawtooth wave modulation can produce a linear frequency progression, resulting in a harmonic profile where the sidebands increase linearly in frequency. Triangle wave modulation can generate sidebands with a symmetric harmonic distribution, where the sidebands are evenly spaced around the fundamental frequency.

The signal modulator 1914 can modulate the light signal generated by the light source 1912 to produce an optical frequency comb. For example, the signal modulator 1914 can use techniques such as frequency modulation (FM), amplitude modulation (AM), or phase modulation (PM) to alter the frequency, amplitude, and/or phase of the light signal. This modulation can produce multiple optical frequency components, collectively referred to as the optical frequency comb. The optical frequency comb can include the multiple frequency components produced by the combination of the carrier frequency of the light signal and an RF frequency applied by the signal modulator 1914. In some cases, the production of the optical frequency comb can improve the signal-to-noise ratio of the system 1900 and reduce susceptibility to interference fading. For example, the sidebands can interact variably with Rayleigh backscatter within an optical fiber, providing differentiated signal strengths at distinct frequencies and improving the sensitivity of detecting and locating acoustic anomalies.

The characteristics of an optical frequency comb can vary based on the type of modulation used. There can be at least two types of modulation patterns: sinusoidal and harmonic-rich, non-sinusoidal. Sinusoidal modulation, such as sine wave modulation, can provide symmetrically spaced sidebands centered around the fundamental frequency and its harmonics.

This type of modulation can be cleaner and more regular, making it suitable for applications requiring precise frequency control and predictable harmonic spacing.

Harmonic-rich, non-sinusoidal modulation can produce a more complex and varied sideband structure. This type of modulation can include patterns such as square, sawtooth, or triangle waveforms, each creating distinct harmonic characteristics in the output signal. Harmonic-rich, non-sinusoidal modulation can offer a denser and more varied frequency comb, which can be advantageous for some applications, such as those requiring a broader frequency coverage and improved interaction with various optical phenomena, such as Rayleigh backscatter.

As an example, square wave modulation can generate sidebands that are spaced more closely together compared to sine wave modulation. This increased density of sidebands can enhance the system's ability to interact with a wider range of frequencies, beneficial for applications needing extensive frequency coverage. Square wave modulation can provide a denser comb structure, improving the system's performance in specific scenarios.

As another example, sawtooth wave modulation can produce a linear frequency progression, resulting in a harmonic profile where the sidebands increase linearly in frequency. This linear increase can offer a different harmonic characteristic, potentially providing advantages in applications benefiting from a linear frequency response. Sawtooth wave modulation can create sidebands with a progressive frequency structure, suitable for linear frequency modulation requirements.

As another example, triangle wave modulation can generate sidebands with a symmetric harmonic distribution, where the sidebands are evenly spaced around the fundamental frequency. This symmetric distribution can provide a balanced frequency comb, advantageous for applications requiring uniform sideband spacing and consistent frequency intervals. Triangle wave modulation can produce sidebands with a symmetric and predictable harmonic distribution.

In cases where the signal modulator 1914 applies harmonic-rich, non-sinusoidal modulation, the light signal can be characterized by a fundamental frequency and a series of odd or odd and even harmonic frequencies. The outputted optical pulse can then include sidebands for the fundamental frequency and at least one of the odd harmonic frequencies, such as the 19st, 3rd, and/or 5th harmonic frequencies. In some such cases, the sidebands can be spaced apart with a guard band between adjacent sidebands. In some cases, for example to ensure statistical independence of the harmonic lobes, the harmonic lobes can be separated by a sufficiently wide guard band. This width can be greater than the inverse of the pulse width generated by the optical comb generator output.

It will be appreciated that other modulation techniques can also be used in the signal modulator 1914 to produce the optical frequency comb. For example, in some cases, the modulation pattern can be a chirped modulation, where the frequency of the signal increases or decreases over time, resulting in a swept-frequency comb. In some cases, amplitude modulation (AM) can be used to vary the intensity of the light signal, creating additional modulation sidebands. In some cases, phase shift keying (PSK) can be applied to modulate the phase of the light signal in discrete steps, generating a comb with specific phase characteristics. These variations in the implementation of the signal modulator 1914 can provide flexibility in the system's performance for different applications.

The optical fiber system 1920 can transmit the modulated light signal from the comb generator 1910 to a structure under observation and return a signal indicative of any acoustic anomalies. The implementation of the optical fiber system 1920 can vary across embodiments. For example, in some cases, the optical fiber can be a single-mode fiber, which can provide high precision and low loss over long distances. As another example, the optical fiber can be a multi-mode fiber, which can be used for shorter distances and can be more cost-effective. In some cases, the optical fiber can include a polarization-maintaining fiber to reduce polarization-induced fading and improve signal stability. In some cases, the optical fiber can be configured with specialized coatings or sheathing to enhance durability and environmental resistance. The optical fiber system 1920 can be selected based on specific requirements such as signal integrity, distance, and environmental conditions.

The data acquisition system 1930 can receive the returned signal from the optical fiber system 1920 and process it to identify and locate acoustic anomalies within the monitored structure. The data acquisition system 1930 can be an embodiment of any of the optical interferometers, as described herein. For example, the data acquisition system 1930 can include one or more optical interferometers configured to combine and separate light signals. The system can also include an optical fiber delay coil to introduce a controlled time delay in the light signals. The signal acquisition and processing system can then determine the characteristics of the acoustic disturbances based on the processed light signals.

U.S. patent application Ser. No. 18/787,495 (the '495 application), filed Jul. 29, 2024, entitled “Optical Frequency Comb Generator For Distributed Acoustic Anomaly Detection,” describes various embodiments and features related to optical frequency comb generators for distributed acoustic anomaly detection. The '495 application is hereby incorporated by reference in its entirety. Some or all of the embodiments and/or features described herein can be used or otherwise combined together or with any of the embodiments and/or features described in the '495 application.

The acoustic anomaly source 1940 represents potential sources of acoustic anomalies within the monitored structure. In some cases, the acoustic anomaly source 1940 can be a pipeline, where anomalies such as leaks, strain variations caused by pressure changes, intrusion, or tensioned reinforcing failures can be detected. As another example, the acoustic anomaly source 1940 can be a bridge, where structural issues such as tensioned reinforcing failures can be monitored. In some cases, the acoustic anomaly source 1940 can be part of a building's infrastructure, detecting events like potential strikes during construction. In some cases, the acoustic anomaly source 1940 can be any civil structure where acoustic monitoring is critical for maintenance and safety.

### Terminology

Although this disclosure has been described in the context of certain embodiments and examples, it will be understood by those skilled in the art that the disclosure extends beyond the specifically disclosed embodiments to other alternative embodiments and/or uses and obvious modifications and equivalents thereof. In addition, while several variations of the embodiments of the disclosure have been shown and described in detail, other modifications, which are within the scope of this disclosure, will be readily apparent to those of skill in the art. It is also contemplated that various combinations or sub-combinations of the specific features and aspects of the embodiments may be made and still fall within the scope of the disclosure. For example, features described above in connection with one embodiment can be used with a different embodiment described herein and the combination still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this invention may include, additional to its essential features described herein, one or more features as described herein from each other embodiment of the invention disclosed herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. An optical interferometer comprising:
an optical coupler configured to combine first light signals traversing a first path and second light signals traversing a second path to form combined light signals, the optical coupler further configured to separate the combined light signals into at least the second path and a third path,
wherein the first light signals correspond to optical light signals that are indicative of acoustic disturbances across a distributed acoustic sensing system, and wherein the second path is a feedback loop; and
an optical fiber delay coil arranged along the second path and configured to introduce a controlled time delay in the second light signals traversing the second path,
wherein a signal acquisition and processing system determines characteristics of the acoustic disturbances based at least in part on third light signals traversing the third path.

2. The optical interferometer of claim 1, wherein the optical coupler receives the first light signals from a sensing optical fiber positioned proximate to a structure such that the first light signals are modulated by acoustic disturbances corresponding to at least one of structural defects or environmental changes in the structure.

3. The optical interferometer of claim 1, wherein the optical coupler is a first optical coupler, the optical interferometer further comprising a second optical coupler arranged along the second path, wherein the second optical coupler is configured to receive a second path signal from the first optical coupler, and separate the second path signal into a path to the signal acquisition and processing system and a path to the optical fiber delay coil.

4. The optical interferometer of claim 1, wherein the optical coupler is a first optical coupler, wherein the combined light signals are first combined light signals, and wherein the the optical interferometer further comprises:
a second optical coupler arranged along the first path, wherein the second optical coupler is configured to receive the optical light signals that are indicative of acoustic disturbances and separate the optical light signals into the first light signals and a fourth path; and
a third optical coupler configured to combine light signals traversing the third path and light signals traversing the fourth path to form second combined light signals, the optical coupler further configured to separate the combined light signals into at least a fifth path and a sixth path.

5. The optical interferometer of claim 1, wherein the optical fiber delay coil is a first optical fiber delay coil, and wherein the optical interferometer further comprises a second optical fiber delay coil arranged along the third path.

6. The optical interferometer of claim 5, wherein the optical coupler is a first optical coupler, wherein the combined light signals are first combined light signals, and wherein the optical interferometer further comprises:
a second optical coupler arranged along the third path, wherein the second optical coupler is configured to combine an output of the second optical fiber delay coil and light signal from the first optical coupler to second combined light signals, the second optical coupler further configured to separate the second combined light signals into at least two paths.

7. The optical interferometer of claim 1, wherein the optical coupler is a 1×2, 2×2, or 3×3 coupler.

8. The optical interferometer of claim 1, wherein the optical fiber delay coil has a length less than 50 meters.

9. The optical interferometer of claim 1, wherein the distributed acoustic sensing system includes a plurality of optical interferometers arranged in parallel.

10. The optical interferometer of claim 1, wherein the controlled time delay is about 2 μs.

11. A distributed acoustic sensing system, comprising:
a sensing optical fiber configured to transmit first light signals along a first path, the sensing optical fiber positioned proximate to a structure such that the first light signals are modulated by acoustic disturbances corresponding to at least one of structural defects or environmental changes in the structure; and
an optical interferometer, comprising:
an optical coupler configured to receive the first light signals and combine first light signals traversing the first path and second light signals traversing a second path to form combined light signals, the optical coupler further configured to separate the combined light signals into at least the second path and a third path, wherein the second path is a feedback loop; and
an optical fiber delay coil arranged along the second path and configured to introduce a controlled time delay in the second light signals traversing the second path.
wherein a signal acquisition and processing system determines characteristics of the acoustic disturbances based at least in part on third light signals traversing the third path.

12. The distributed acoustic sensing system of claim 11, further comprising the signal acquisition and processing system.

13. The distributed acoustic sensing system of claim 11, wherein the optical coupler is a 1×2, 2×2, or 3×3 coupler.

14. The distributed acoustic sensing system of claim 11, further comprising a second optical fiber delay coil arranged along the second path and configured to introduce an additional controlled time delay in the second light signals traversing the second path.

15. The distributed acoustic sensing system of claim 11, wherein the controlled time delay introduced by the optical fiber delay coil creates interference patterns characterized by alternating light and dark bands, wherein the system further comprises a signal acquisition and processing system configured to:
receive and digitize the interference patterns;
analyze phase shifts in the interference patterns to detect acoustic disturbances; and
determine characteristics of the acoustic disturbances based on the interference patterns.

16. The distributed acoustic sensing system of claim 13, wherein the characteristics of the acoustic disturbances comprise at least a location of the acoustic disturbances, wherein the location comprises an indication of an approximate position along a length of the sensing optical fiber where the acoustic disturbances are detected.

17. The distributed acoustic sensing system of claim 13, further comprising a hybrid phase detection device, wherein the hybrid phase detection device is configured to:
split the third light signals into two or more paths;
mix the split light signals with a reference signal to produce in-phase (I) and quadrature (Q) components;
generate phase-shifted output signals based on the I and Q components;
compare the phase-shifted output signals to determine phase differences; and
provide phase difference data to the signal acquisition and processing system for further analysis of the acoustic disturbances.

18. A method for detecting acoustic disturbances using an optical interferometer, comprising:
splitting first light signals indicative of acoustic disturbances into a first path and a second path using an optical coupler, wherein the first light signals traverse the first path and the second path;
introducing a controlled time delay in second light signals traversing the second path using an optical fiber delay coil arranged along the second path;
combining the first light signals and the time-delayed second light signals to form combined light signals using the optical coupler; and
separating the combined light signals into at least the second path and a third path using the optical coupler, wherein the second path forms a feedback loop for subsequent signals and the third path provides output signals;
wherein a signal acquisition and processing system determines characteristics of the acoustic disturbances based at least in part on the light signals traversing the third path.

19. The method of claim 18, wherein the controlled time delay introduced by the optical fiber delay coil creates interference patterns characterized by alternating light and dark bands further comprising:
analyzing phase shifts in the interference patterns to detect acoustic disturbances; and
determining characteristics of the acoustic disturbances based on the interference patterns.

20. The method of claim 18, wherein the characteristics of the acoustic disturbances comprise at least a location of the acoustic disturbances, wherein the location comprises an indication of an approximate position along a length of a sensing optical fiber where the acoustic disturbances are detected.
